(19) United States
(12) Patent Application Publication
(10) Pub. No.: US 2004/0052725 A1
(43) Pub. Date: Mar. 18, 2004

(54) Oxidized metal catalysts and process for producing synthesis gas

(75) Inventors: Tianyan Niu, Ponca City, OK (US); Daxiang Wang, Ponca City, OK (US); David Minahan, Stillwater, OK (US); Baili Hu, Ponca City, OK (US); Harold A. Wright, Ponca City, OK (US)

Correspondence Address: DAVID W. WESTPHAL, CONOCOPHILLIPS COMPNAY, P.O. BOX 1267, PONCA CITY, OK, 74602-1267, US

(73) Assignee: ConocoPhillips Company, Houston, TX

(21) Appl. No.: 10/610,021

(22) Filed: Jun. 30, 2003

Related U.S. Application Data
(60) Provisional application No. 60/392,481, filed on Jun. 28, 2002.

(51) Int. Cl. B01J 23/10

(52) U.S. Cl. 423/651; 502/302

(57) ABSTRACT

The present invention generally relates to catalysts comprising at least one oxidized active metal; at least one lanthanide; and a refractory support. The active metal is selected from the group consisting of rhodium, ruthenium, rhenium, platinum, palladium, iridium, and osmium. In particular, the present invention relates to catalysts effective for initiating and sustaining the partial oxidation of light hydrocarbons, preferably methane, to a product mixture comprising carbon monoxide and hydrogen, e.g. synthesis gas. The present invention still further discloses a method of making a supported synthesis gas catalyst comprising an oxidized metal and at least one lanthanide.

### CROSS REFERENCE TO RELATED APPLICATIONS

This non-provisional patent application claims the benefit of U.S. Provisional Patent Application Serial No. 60/392,481 filed Jun. 28, 2002.

### FIELD OF THE INVENTION

The present invention generally relates to a method of making supported catalysts and to catalysts made therefrom, where the supported catalysts comprise at least one lanthanide and at least one oxidized active metal selected from the group consisting of rhodium, ruthenium, rhenium, platinum, palladium, iridium, and osmium. In particular, the present invention relates to catalysts effective for initiating and sustaining the partial oxidation of light hydrocarbons, preferably methane, to a product mixture comprising carbon monoxide and hydrogen, e.g. synthesis gas. The present invention still further discloses a method of producing synthesis gas using supported catalysts comprising an oxidized active metal and at least one lanthanide.

### BACKGROUND OF THE INVENTION

Large quantities of methane, the main component of natural gas, are available in many areas of the world, and natural gas is predicted to outlast oil reserves by a significant margin. However, most natural gas is situated in areas that are geographically remote from population and industrial centers. The costs of compression, transportation, and storage make its use economically unattractive.

To improve the economics of natural gas use, much research has focused on methane as a starting material for the production of higher hydrocarbons and hydrocarbon liquids. The conversion of methane to hydrocarbons is typically carried out in two steps. In the first step, methane is reformed with water to produce carbon monoxide and hydrogen (i.e., synthesis gas or syngas). In a second step, the syngas intermediate is converted to higher hydrocarbon products by processes such as the Fischer-Tropsch synthesis. For example, fuels with boiling points in the middle distillate range, such as kerosene and diesel fuel, and hydrocarbon waxes may be produced from the synthesis gas.

Current industrial use of methane as a chemical feedstock proceeds by the initial conversion of methane to carbon monoxide and hydrogen by either steam reforming or dry reforming. Steam reforming currently is the major process used commercially for the conversion of methane to synthesis gas, the reaction proceeding according to Equation 1.

CH₄+H₂O→CO+3H₂ (1)

Although steam reforming has been practiced for over five decades, efforts to improve the energy efficiency and reduce the capital investment required for this technology continue. The steam reforming reaction is endothermic (about 49 kcal/mol), requiring the expenditure of large amounts of fuel to produce the necessary heat for the industrial scale process. Another drawback of steam reforming is that for many industrial applications, the 3:1 ratio of H₂:CO products is problematic, and the typically large steam reforming plants are not practical to set up at remote sites of natural gas formations.

Methane residence times in steam reforming are on the order of 0.5-1 second, whereas for heterogeneously catalyzed partial oxidation, the residence time is on the order of a few milliseconds. For the same production capacity, syngas facilities for the partial oxidation of methane can be far smaller, and less expensive, than facilities based on steam reforming. A recent report (M. Fichtner et al. Ind. Eng. Chem. Res. (2001) 40:3475-3483) states that for efficient syngas production, the use of elevated operation pressures of about 2.5 MPa is required. Those authors describe a partial oxidation process in which the exothermic complete oxidation of methane is coupled with the subsequent endothermic reforming reactions (water and CO₂ decomposition). This type of process can also be referred to as autothermal reforming or ATR, especially when steam is co-fed with the methane. Certain microstructured rhodium honeycomb catalysts are employed which have the advantage of a smaller pressure drop than beds or porous solids (foams) and which resist the reaction heat of the total oxidation reaction taking place at the catalyst inlet.

The catalytic partial oxidation (“CPOX”) of hydrocarbons, e.g., methane or natural gas, to syngas has also been described in the literature. In catalytic partial oxidation, natural gas is mixed with air, oxygen-enriched air, or oxygen, and introduced to a catalyst at elevated temperature and pressure. The partial or direct oxidation of methane yields a syngas mixture with a H₂:CO ratio of 2:1, as shown in Equation 2.

CH₄+½O₂→CO+2H₂ (2)

This ratio is more useful than the H₂:CO ratio from steam reforming for the downstream conversion of the syngas to chemicals such as methanol or to fuels. The CPOX reaction is exothermic (−8.5 kcal/mol), in contrast to the strongly endothermic steam reforming reaction. Furthermore, oxidation reactions are typically much faster than reforming reactions. This allows the use of much smaller reactors for catalytic partial oxidation processes than is possible in a conventional steam reforming process. Other methane oxidation reactions include the highly exothermic total combustion (−192 kcal/mol) and partial combustion (−124 kcal/mol) reactions, Equations 3 and 4, respectively.

CH₄+2O₂→CO₂+2H₂O (3)

CH₄+3/2O₂→CO+2H₂O (4)

While its use is currently limited as an industrial process, the direct partial oxidation or CPOX of methane has recently attracted much attention due to its inherent advantages, such as the fact that due to the significant heat that is released during the process, there is no requirement for the continuous input of heat in order to maintain the reaction, in contrast to steam reforming processes. An attempt to overcome some of the disadvantages and costs typical of steam reforming by production of synthesis gas via the catalytic partial oxidation of methane is described in European Patent No. 303,438. The process of the '438 patent comprises partially oxidizing a hydrocarbonaceous feedstock by passing a gaseous mixture comprising a hydrocarbonaceous feedstock, oxygen or an oxygen-containing gas and, optionally, steam through a catalyst capable of catalyzing the oxidation of the hydrocarbons wherein the catalyst may comprise metals or metal oxides known to have activity as oxidation catalysts.

U.S. Pat. No. 5,149,464 to Green et al. describes a method for selectively converting methane to syngas by contacting a methane/oxygen mixture with a solid catalyst which is a d-block transition metal on a refractory support, an oxide of a d-block transition metal, or a compound of the formula MₓM′_{y}O_{z} wherein M′ is a d-block transition metal and M is Mg, B, Al, Ga, Si, Ti, Zr, Hf or a lanthanide.

A. T. Ashcroft, et al. (Nature 344:319-321 (1990)) describe the selective oxidation of methane to synthesis gas using ruthenium-lanthanide containing catalysts. The reaction was carried out at a gas hourly space velocity (GHSV) of 4×10⁴ hr⁻¹ and normal atmospheric pressure. A nitrogen diluent was employed to enhance activity and selectivity.

U.S. Pat. No. 5,500,149 describes the combination of dry reforming and partial oxidation of methane, in the presence of added CO₂ to enhance the selectivity and degree of conversion to synthesis gas. The catalyst comprises a d-block transition metal or oxide such as a Group 8,9 or 10 metal on a metal oxide support such as alumina, and is made by precipitating the metal oxides, or precursors thereof such as carbonates or nitrates or any thermally decomposable salts, onto a refractory solid which may itself be massive or particulate; or one metal oxide or precursor may be precipitated onto the other. Preferred catalyst precursors according to the '149 patent are those having the catalytic metal highly dispersed on an inert metal oxide support and in a form readily reducible to the elemental state.

European patent 0 640 561 B1 describes a catalyst comprising a metal selected from Groups 8,9 or 10 of the Periodic Table supported on a refractory oxide having at least two cations for a process for the catalytic partial oxidation of a methane containing feed.

Ruckenstein and Wang (Appl. Catal., A (2000), 198:33-41) describe certain MgO supported Rh catalysts which, at 750° C. and 1 atm, provided a conversion >80% and selectivities of 95-96% to CO and 96-98% to H₂, at the high space velocity of 7.2×10⁵ mL/g⁻¹ h⁻¹, with very high stability.

For successful commercial scale operation a catalytic partial oxidation process must be able to achieve and sustain a high conversion of the methane feedstock at high gas hourly space velocities, with high selectivity for the desired H₂ and CO products. Moreover, such high conversion and selectivity levels must be achieved without detrimental effects to the catalyst, such as the formation of carbon deposits (coke) on the catalyst, which severely reduces catalyst performance. The choice of catalyst composition and the manner in which the catalyst is made are important factors in determining whether a catalyst will have sufficient physical and chemical stability. In particular, the composition and manner of making will dictate the on stream stability of the catalyst over extended periods of time at moderate to high temperatures. Moreover, these factors may influence the ability of a catalyst to preclude high pressure drop on-stream in a synthesis gas production operation.

In most of the existing syngas production processes it is difficult to select a catalyst that will be economical for large scale industrial use, yet will provide the desired level of activity and selectivity for CO and H₂ and demonstrate long on-stream life. Today, metal oxide supported noble metal catalysts or mixed metal oxide catalysts are most commonly used for the selective oxidation of hydrocarbons and for catalytic combustion processes. Various techniques are employed to prepare the catalysts, including impregnation, washcoating, xerogel, aerogel or sol gel formation, spray drying and spray roasting. Monolith supported catalysts having pores or longitudinal channels or passageways are commonly used. Such catalyst forming techniques and configurations are well described in the literature, for example, in Structured Catalysts and Reactors, A. Cybulski and J. A. Moulijn (Eds.), Marcel Dekker, Inc., 1998, p. 599-615 (Ch. 21, X. Xu and J. A. Moulijn, “Transformation of a Structured Carrier into Structured Catalyst”).

U.S. Pat. No. 5,510,056 discloses a ceramic foam supported Ru, Rh, Pd, Os, Ir or Pt catalyst having a specified tortuosity and number of interstitial pores that is said to allow operation at high gas space velocity. The catalyst is prepared by depositing the metal on a carrier using an impregnation technique, which typically comprises contacting the carrier material with a solution of a compound of the catalytically active metal, followed by drying and calcining the resulting material. The catalyst is employed for the catalytic partial oxidation of a hydrocarbon feedstock.

U.S. Pat. No. 5,648,582 discloses a rhodium or platinum catalyst prepared by washcoating an alumina foam monolith having an open, cellular, sponge-like structure. The catalyst is used for the catalytic partial oxidation of methane at space velocities of 120,000 h.⁻¹ to 12,000,000 h⁻¹

PCT Patent Application Publication No. WO 93/01130 describes another catalyst for the production of carbon monoxide from methane. The catalyst is composed of Pd, Pt, Rh or Ir on a pure lanthanide oxide, which may be carried on a ceramic support, preferably zirconia. Pd on Sm₂O₃ gives relatively low selectivity for either CO or CO₂, compared to the selectivities reported for the other compositions evaluated in that study. The methane conversion process is performed with supplied heat, the feed gases comprise very low amounts of O₂ , and very low amounts of H₂ are produced as a byproduct of the process.

Lapszewicz, et al. (Proceedings of the Symposium on Chemistry and Characterization of Supported Metal Catalysts presented before the Division of Petroleum Chemistry, Inc. 206^{th} National Meeting, American Chemical Society, Chicago, Ill., (Aug. 22-27, 1993) pp. 815-818) describe the use of certain Rh catalysts on pure Sm₂O₃ and Pt group metals on MgO for catalyzing the partial oxidation of natural gas to syngas. That report focuses on CH₄ conversion to carbon monoxide, which reaches a maximum level of 80% using 0.5% Rh on Sm₂O₃ as the catalyst.

U.S. Pat. No. 5,639,401 relates to a process for the catalytic partial oxidation of a hydrocarbon feedstock comprising contacting a feed comprising a hydrocarbon feed stock and an oxygen containing gas with a catalyst at an elevated temperature under conditions such the catalyst will be susceptible to a thermal shock, the catalyst having the form of a porous monolithic structure comprising a catalytically active metal supported on a zirconia based carrier.

European patent 1 134 188 describes a reduced metal catalyst consisting of a transition or noble metal selected from Ni, Co, Fe, Pt, Pd, Ir, Re, Ru, on a monolith substrate under conditions that initiate the partial oxidation reaction.

U.S. Patent Application 2001/0041159 A1 describes a process and a metal for the partial oxidation of hydrocarbons to produce hydrogen and carbon monoxide. The metal catalyst is a transition or noble metal supported on a ceria monolith substrate.

Hohn and Schmidt (Applied Catalysis A: General 211:53-68 (2001)) compare monolith and particulate (i.e., sphere) beds in a catalytic partial oxidation process, and show that a non-porous alumina support gave better results for the production of synthesis gas, even at space velocities of 1.8×10⁶ h⁻¹, compared to a comparable alumina monolith support.

U.S. Patent Application No. 2001/0027258 A1 describes a catalytic partial oxidation process that includes contacting a C₁-C₄ hydrocarbon and oxygen with a bed of particulate, supported Group 8,9 or 10 metal catalyst. The support has a surface to volume ratio of about 15-230 cm⁻¹ and the preferred catalyst particle size range is about 200-2000 microns in diameter. The preferred support particles generally have a low total surface area, e.g., <20 m²/gm, and microposity is not important to the process.

As mentioned hereinabove, selective oxidation, i.e. catalytic partial oxidation (CPOX), of methane or light hydrocarbons in the presence of a catalyst or catalyst system to produce synthesis gas is an exothermic process. However, initiation of the catalytic partial oxidation process requires that an activation energy barrier be overcome and this is typically carried out by heating the catalyst in the presence of the reactant gas mixture to a specific “light-off” temperature that corresponds to overcoming the energy barrier associated with the catalytic reaction. The precise light-off temperature is controlled by a number of factors including, for example, feed composition, catalyst composition and catalyst oxidation state. Because a lower light-off temperature ultimately translates into a reduction in capital and operational costs, several in the art have attempted to address this issue by altering the nature of the catalyst, which governs, in part, the threshold light-off temperature.

It is well-known within the art of selective methane oxidation catalysts that the active catalytic sites may be prepared by reducing noble metals. For example, U.S. Pat. No. 6,254,807, teach a process for enhancing H₂ or CO production in a partial oxidation reaction by feeding H₂O or CO₂ with the feed hydrocarbon and oxygen over a transition metal monolith catalyst or alternatively contacting the hydrocarbon/oxygen first with a noble metal then with a transition metal with the H₂O or CO₂ being added before or after the noble metal catalyst. The noble metal (Rh and Pt) catalysts were prepared by impregnation of α-Al₂O₃ with a concentrated metal salt solution, drying at 390° K, calcining at 870° K and reducing at 870° K in 10% H₂/Ar for 7 hours. U.S. Pat. No. 5,654,491 is directed to a process for the partial oxidation of hydrocarbons to form relatively high concentrations of oxygenates and relatively low concentrations of CO and CO₂. A preferred process according to the '491 patent uses a catalyst structure containing one or more Group 8, 9 or 10 metals to partially oxidize normal alkanes associated with remote sources of natural gas into more valuable liquid fuels and chemicals, such as oxygenates.

De Smet et al., in Studies in Surface Science and Catalysis, Vol. 119, pp. 825-829 describes a rhodium on alpha alumina catalyst examined for its activity and selectivity in the partial oxidation of methane. De Smet et al. conclude that the rhodium catalyst can exist in a low activity oxidized state or a high activity reduced state. De Smet et al. further note that reforming reactions take place only in the reduced state.

Jin et al., in Applied Catalysis A: General (2000) vol. 201, pp. 71-80, describes the catalytic partial oxidation of methane (POM) over a Group 10 metal catalyst, in particular, a Ni/α-Al₂O₃ catalyst. It is notable that when the oxidation state of the nickel was transformed from Ni(II) to Ni(0) at a certain critical temperature the reaction was transformed rapidly from the complete oxidation of methane to the partial oxidation of methane. The results indicated that the NiO species were first reduced to Ni(0) species and then CH₄ began to dissociate over Ni(0) sites.

PCT Patent Application Publication No. WO 02/20395 to Allison et al. discloses lanthanide-promoted rhodium-containing supported catalysts that are active for catalyzing the net partial oxidation of methane to CO and H₂, along with their manner of making and high efficiency processes for producing synthesis gas employing the new catalysts.

Although significant advances have been made in the development of catalysts and processes for producing synthesis gas, in order for catalytic partial oxidation processes to be commercially feasible there continues to be a need for more efficient and economical processes for which improved catalysts are required. As evidenced by the fact that there are no commercially practiced CPOX reaction systems for the manufacture of synthesis gas, the process needs to be made easier to practice, not dependent upon additional ignition sources, and capable of lighting off at low temperatures. Ideal syngas catalysts would also be physically and chemically stable on stream and resist coking, and also retain a high level of conversion activity and selectivity to carbon monoxide and hydrogen under the conditions of high gas space velocity and elevated pressure that are needed for achieving high space time syngas yield.

### SUMMARY OF THE INVENTION

The present invention is based on the unexpected discovery that CPOX catalysts comprising at least one metal oxide, at least one lanthanide and a refractory metal support demonstrate a surprisingly high level of activity and selectivity to carbon monoxide and hydrogen under conditions of high gas hourly space velocity, elevated pressure and high temperature. This is particularly surprising as it is well-known, for nearly all heterogeneous catalytic processes, that catalytic metals are most active in their reduced state. Indeed, the present catalysts perform decidedly better than partial oxidation catalysts comprising reduced metals, the present catalysts being chiefly characterized by a selectivity and activity that is higher than that found in an identical partial oxidation catalyst differing solely in oxidation state of the catalytic metal. Moreover, it has been discovered that the inventive metal oxide catalyst is characterized by a lower activation temperature in the catalytic partial oxidation reaction of small hydrocarbons, such as methane, for example as compared to a comparable CPOX catalyst comprising a reduced metal component. As discussed hereinabove, a lower activation temperature can directly result in reduced operating costs. As an added advantage, the present catalyst comprises an oxidized metal, thereby precluding the inclusion of a reduction step in making the present catalyst. The absence of a reduction step in the method of making the catalyst reduces costs and increases method efficiency. The present catalyst further comprises at least one lanthanide. The improved activity for syngas generation of the present catalyst under a variety of operating conditions and at lower temperatures than reported in earlier work is at least partially attributable to the presence in the inventive catalyst of the lanthanide element. Yet another inventive feature of the present catalyst is the ability to operate at pressures above atmospheric pressure. In addition, the present catalyst retains its original activity and selectivity even after periods of operation lasting days. In particular, the present catalyst shows no evidence of coking after extended operation. The present invention also discloses a process for making synthesis gas using the inventive catalyst. The improvements in catalyst stability, activity and selectivity manifest themselves in terms of improvements in process efficiency, namely, constant exit temperatures and product compositions from the synthesis gas reactor. The features of the present catalyst recited herein address long-standing deficiencies of the CPOX process and may pave the way for the eventual replacement of the classic steam reforming process.

The present invention discloses, in one aspect, a method of making a catalyst comprising at least one oxidized metal and at least one lanthanide wherein said catalyst is effective for at least partially oxidizing a reactant gas comprising at least one hydrocarbon and oxygen to a product stream comprising hydrogen and carbon monoxide, e.g. synthesis gas, wherein the method of making the catalyst comprises a) depositing at least one metal-containing compound onto a refractory support; and b) depositing at least one lanthanide-containing compound onto a refractory support; in a manner effective for producing a catalyst precursor material; and c) calcining the catalyst precursor material under conditions effective for producing a catalyst comprising an oxidized metal.

The present invention further discloses a catalyst effective for at least partially oxidizing a reactant gas comprising at least one hydrocarbon and oxygen to a product stream comprising hydrogen and carbon monoxide said catalyst comprising (a) at least one oxidized metal wherein the metal is selected from the group consisting of rhodium, ruthenium, rhenium, platinum, palladium, iridium, and osmium; (b) at least one lanthanide; and (c) a refractory support.

The present invention also discloses a process for at least partially oxidizing a reactant gas comprising at least one hydrocarbon, e.g. methane or natural gas, and oxygen wherein the process comprises contacting a catalyst with the reactant gas under conditions sufficient to (a) initiate the partial oxidation reaction; and (b) provide a product stream comprising hydrogen and carbon monoxide wherein the catalyst comprises at least one oxidized metal wherein the metal is selected from the group consisting of rhodium, ruthenium, rhenium, platinum, palladium, iridium, and osmium; and at least one lanthanide; and a refractory support.

### DETAILED DESCRIPTION OF THE INVENTION

### Method Of Making Catalyst

The present invention discloses a method of making an oxidized metal catalyst. The catalyst comprises (a) at least one oxidized metal wherein the metal is selected from the group consisting of rhodium, ruthenium, rhenium, platinum, palladium, iridium, and osmium; (b) at least one lanthanide; and (c) a refractory support. The catalyst is effective for at least partially oxidizing a reactant gas comprising at least one hydrocarbon and oxygen to a product stream comprising hydrogen and carbon monoxide. The present method comprises (a) depositing at least one metal-containing compound onto a refractory support and (b) depositing at least one lanthanide-containing compound onto a refractory support; in a manner effective for producing a catalyst precursor material; and (c) calcining the catalyst precursor material under conditions effective for producing a catalyst comprising an oxidized metal.

As used herein, “partial oxidation” means any process that is something less than complete oxidation. For example, complete oxidation of a hydrocarbon provides only carbon dioxide and water as the products whereas partial oxidation results in at least some of the hydrogen and carbon being less than completely oxidized, to provide, for example carbon monoxide and hydrogen.

The catalyst is effective for at least partially oxidizing a reactant gas comprising at least one hydrocarbon and oxygen to a product stream comprising hydrogen and carbon monoxide. Conceivably any light hydrocarbon could be used in the present invention. Particularly suitable hydrocarbons are the common gaseous hydrocarbons including methane, ethane, ethylene, propane, propylene, butane, 1-butene, 2-butene, isobutene, isobutylene and pentane isomers. Methane is a particularly preferred hydrocarbon. Natural gas is comprised mostly of methane and is a preferred reactant gas for use in the current invention.

According to one embodiment of the present method, the method comprises sequentially applying a metal salt, to a lanthanide and/or lanthanide oxide precursor, such as a lanthanide salt, to the refractory support and stabilizing the catalyst. The term “refractory support” refers to any material that is mechanically stable to the high temperatures of a catalytic partial oxidation reaction, which is typically 500° C.-1,600° C., but may be as high as 200° C. Suitable refractory support materials include zirconia, magnesium stabilized zirconia, zirconia stabilized alumina, yttrium stabilized zirconia, calcium stabilized zirconia, alumina, magnesium modified alumina, lanthanide modified alumina, cordierite, titania, silica, magnesia, niobia, vanadia, carbide, silicon carbide, nitride, carbide-nitride, or any combination thereof. A preferred refractory support material is alpha-alumina. Stabilizing includes thermally conditioning the catalyst. The refractory support can be a refractory monolith or a plurality of distinct or discrete structures or particulates. The terms “distinct” or “discrete” structures or units, as used herein, refer to supports in the form of divided materials such as granules, beads, pills, pellets, cylinders, trilobes, extrudates, spheres or other rounded shapes, or another manufactured configuration. Alternatively, the divided material may be in the form of irregularly shaped particles. Preferably at least a majority (i.e., >50%) of the particles or distinct structures have a maximum characteristic length (i.e., longest dimension) of less than six millimeters, preferably less than three millimeters. The term “monolith” as used herein is any singular piece of material of continuous manufacture such as solid pieces of metal or metal oxide or foam materials or honeycomb structures. In some embodiments, two or more catalyst monoliths are stacked in the catalyst zone of the reactor.

The present method comprises (a) depositing at least one metal-containing compound and (b) depositing at least one lanthanide-containing compound. Steps (a) and (b) may be carried out simultaneously or separately. According to a preferred embodiment of the method, (a) and (b) are carried out separately. That is, according to one embodiment, the method comprises impregnating a refractory support with a metal-containing compound, i.e. a metal salt, drying the support, and calcining the support; all before application of the lanthanide-containing compound.

In one embodiment, the method of making the oxidized catalyst is a modification of the catalyst synthesis procedure outlined in International Publication WO 02/20395 A2, wherein the modification exists in the deletion or attenuation of the reduction step. In particular, in some embodiments, the method of making an oxidized catalyst for use in the selective oxidation of methane and/or light hydrocarbons comprises deposition of at least one metal-containing compound onto a porous refractory support. The metal in the metal-containing compound is chosen from the group consisting of d-block transition metals, Group 8,9 or 10 metals, Rh metal and the combinations thereof. The method of making an oxidized catalyst further comprises deposition of at least one lanthanide metal-containing compound onto a porous refractory support. The lanthanides refer to the rare earth elements La, Ce, Pr, Nd, Pm, Sm, Eu, Gd, Th, Dy, Ho, Er, Tm, Lu and Yb. The porous refractory support may include partially-stabilized zirconia (PSZ), zirconia, alumina, α-Al₂O₃, titania, corderite, mullite, Zr-stabilized α-Al₂O₃. The porous refractory support may be formed as a monolith, foam, granules, particles, pellets, beads, spheres, cylinders, trilobes or other manufactured shapes.

The method of making an oxidized catalyst further comprises thermal treatment of the porous refractory support wherein the treatment comprises subjecting the porous refractory support, after deposition of the lanthanide-containing compound and/or after deposition of the metal-containing compound, to two or more heat treatments which yield a more stable and longer lived catalyst for use in the CPOX reactor. Each heat treatment includes calcining the catalyst, or an intermediate stage of the catalyst, according to a defined heating and cooling program. Preferably the final heat treatment includes heating at a temperature that approaches or approximates the operating temperature of the CPOX reactor. It is also preferable to apply the lanthanide-containing compound to a refractory support first, followed by a programmed heat treatment, to further enhance catalyst stability when used onstream in a CPOX reactor. The oxidized catalyst so made is used as is, without reduction, in the CPOX reactor.

According to one embodiment, the method may still further comprise reducing the catalyst precursor material wherein at least a portion of the catalyst precursor is at least partially reduced. Preferably, according to this embodiment, all of the precursor material is fully reduced. Also according to this embodiment, the method of making the oxidized catalyst comprises a full reduction followed by an oxidation, wherein the thermal treatment, as described hereinabove, is followed by treating the metal-deposited porous refractory support in a reducing atmosphere at conditions effective to convert the oxidized metal of the catalyst to a reduced metal. The reduced metal catalyst is subsequently re-oxidized to provide oxidized metal catalyst in a final activation step. That is, when reduction is carried out it is preferable that reducing the catalyst precursor takes place prior to calcining the catalyst precursor.

In yet another embodiment, the oxidized catalyst can be partially reduced after thermal treatment and prior to contact with reactant gas, wherein partially reduced is taken to mean that at least a portion of the active catalytic metal sites are in a zero oxidation state.

The present method comprises (c) calcining the catalyst precursor. According to one embodiment of the method of making the catalyst, calcining the catalyst precursor comprises at least one thermal conditioning step wherein said thermal conditioning comprises (a) heating the catalyst precursor material in air at a first heating rate up to a first temperature; and (b) heating the catalyst precursor material in air at a second heating rate from the first temperature to a second temperature. It shall be understood that the first and second heating rates may be same or different.

Thermal conditioning may also be carried out between deposition steps (a) and (b). In particular, (a) depositing at least one metal-containing compound may further comprise at least one thermal conditioning step wherein said thermal conditioning comprises (a) heating the catalyst precursor material in air at a first heating rate up to a first temperature; and (b) heating the catalyst precursor material in air at a second heating rate from the first temperature to a second temperature.

### Catalyst

The present catalyst is effective for at least partially oxidizing a reactant gas comprising at least one hydrocarbon and oxygen to a product stream comprising hydrogen and carbon monoxide. The catalyst comprises (a) at least one oxidized metal wherein the metal is selected from the group consisting of rhodium, ruthenium, rhenium, platinum, palladium, iridium, and osmium; (b) at least one lanthanide; and (c) a refractory support. It has been found that use of an oxidized metal overcomes some of the drawbacks associated with known catalysts comprising said metals. For example, according to one embodiment, the present catalysts comprise oxidized rhodium. Such catalysts have been found to overcome some of the disadvantages associated with known rhodium-based catalysts, providing higher conversion and selectivity toward hydrogen and carbon monoxide in the partial oxidation reaction.

Although the oxidized metal could conceivably be any oxidized d-block transition metal from Groups 3-12, it is preferred that the oxidized metal is selected from the group consisting of ruthenium, rhodium, palladium, osmium, iridium, platinum and any combination thereof. A particularly preferred oxidized metal in the present catalyst is oxidized rhodium.

The catalyst further comprises a lanthanide. The lanthanide is selected from the group consisting of praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), lutetium (Lu), ytterbium (Yb) and any combination thereof. More preferably the lanthanide is selected from the group consisting of praseodymium (Pr), samarium (Sm), ytterbium (Yb) and any combination thereof; while samarium (Sm) is a most preferred lanthanide.

Suitable porous refractory support materials include zirconia, magnesium stabilized zirconia, zirconia stabilized alumina, yttrium stabilized zirconia, calcium stabilized zirconia, alumina, magnesium modified alumina, lanthanide modified alumina, cordierite, titania, silica, magnesia, niobia, vanadia, carbide, silicon carbide, nitride, carbide-nitride, and any combination thereof.

As described hereinabove, the reactant gas may comprise any one or combination of gaseous hydrocarbons including methane, ethane, ethylene, propane, propylene, butane, 1-butene, 2-butene, isobutene and isobutylene. Preferably, the reactant gas comprises natural gas. More preferably, the reactant gas comprises at least methane. The reactant gas further comprises at least one oxidizing component, namely an oxygen source. In particular, oxygen may be introduced to the reactant gas stream in one of many forms including, but not limited to, air, pure molecular oxygen or some combination with air and/or any inert gas, such as oxygen-enriched air or a nitrogen-oxygen mixture. An inert gas is defined as a gas that is incapable of reacting with the catalyst.

The present catalyst is effective for producing a product stream comprising hydrogen and carbon monoxide. Preferably, the product stream comprises hydrogen (H₂) and carbon monoxide (CO) in a ratio between about 5:1 H₂:CO and about 1:2 H₂:CO. More preferably, the product stream comprises hydrogen (H₂) and carbon monoxide (CO) in a ratio between about 1.7:1 and about 2.1:1.

The catalyst comprises at least one oxidized metal. It is believed that the metal oxides confer to the present catalyst greater activity and stability at the high temperatures and pressures encountered during the catalytic partial oxidation (CPOX) process. Moreover, the use of oxides streamlines and eases catalyst preparation; the intermediacy of an oxygen-sensitive precursor comprising reduced metals having been precluded by the nature of the synthesis. Among the metal oxides that may be used in the present invention are those of rhodium, ruthenium, rhenium, platinum, palladium, iridium and osmium. The oxide of rhodium is particularly preferred in the catalyst of the present invention.

The present catalyst further comprises at least one lanthanide. It has been found that the lanthanide favorably promotes the action of the catalytic metal oxide, increasing both activity and selectivity. Preferably that metal is oxidized rhodium.

The oxidized metal catalyst further comprises a support which may be selected from the group consisting of magnesium stabilized zirconia, zirconia stabilized alumina, yttrium stabilized zirconia, calcium stabilized zirconia, alumina, magnesium modified alumina, lanthanide modified cordierite, zirconia, titania, silica, magnesia, niobia, vanadia, silicon-carbide, carbides, nitrides, carbide-nitride or any combination thereof. In certain preferred embodiments the catalyst is about 0.005 to 25 wt % rhodium and about 0.005 to 25 wt % of a lanthanide and/or lanthanide oxide deposited on a porous refractory support, especially partially-stabilized zirconia (PSZ), alpha-alumina, magnesium modified alumina or zirconia. In certain preferred embodiments the lanthanide is samarium. In certain embodiments oxidized Rh and a lanthanide metal and/or lanthanide oxide are deposited on a monolith support that contains about 45-80 pores per linear inch. In other preferred embodiments the catalyst and support comprise a plurality of distinct or discrete structures or particulates, characterized as described above.

In some embodiments the catalyst comprises about 0.05-25 wt % oxidized rhodium and about 0.1-25 wt % lanthanide and/or lanthanide oxide, preferably about 0.5-10 wt % oxidized rhodium and about 0.5-10 wt % lanthanide and/or lanthanide oxide (wt % lanthanide based on total weight of the supported catalyst). In preferred embodiments the lanthanide is deposited between the support and an oxidized rhodium layer. In some embodiments, the catalyst system comprises about 0.5-10 wt % oxidized rhodium over a layer of about 0.5-10 wt % lanthanide, preferably samarium, ytterbium or praseodymium, and oxides thereof, more preferably samarium and/or samarium oxide, deposited on a PSZ or alumina monolith, or, more preferably, on alpha-alumina or zirconia granules having the size characteristics described above. In other embodiments, oxidized Rh is deposited between the monolith support and the lanthanide and/or lanthanide oxide layer. In still other embodiments, a mixture of lanthanide and Rh is deposited on the support. In any case, the catalyst is preferably subjected to one or more thermally conditioning treatments during catalyst construction, as previously described, to yield a more pressure tolerant, high temperature resistant and longer lived catalyst system than is presently available in conventional syngas or catalytic partial oxidation catalysts.

### Process of Oxidizing a Hydrocarbon to Synthesis Gas

Presented herein is a process of preparing synthesis gas using supported oxidized metal catalysts for the catalytic partial oxidation (CPOX) of hydrocarbons. In particular, a method or process of converting a reactant gas that preferably comprises methane or natural gas and further comprises oxygen to a product stream comprising carbon monoxide and hydrogen, preferably in a H₂:CO molar ratio between 1.4:1 and about 2.1:1, more preferably between 1.7:1 and about 2.1:1, is provided. The process comprises mixing a methane-containing feedstock and an O₂ containing feedstock to provide a reactant gas mixture feedstock. Natural gas, or other light hydrocarbons having from 2 to 5 carbon atoms, and mixtures thereof, may also serve as satisfactory feedstocks. The O₂ containing feedstock may be pure oxygen gas, or may be air or O₂-enriched air. The reactant gas mixture may also include incidental or non-reactive species, in lesser amounts than the primary hydrocarbon and oxygen components. Some such species are H₂, CO, N₂, NOₓ, CO₂, N₂O, Ar, SO₂ and H₂S, as can exist normally in natural gas deposits. Additionally, in some instances, it may be desirable to include nitrogen gas in the reactant gas mixture to act as a diluent. Nitrogen can be present by addition to the reactant gas mixture or can be present because it was not separated from the air that supplies the oxygen gas. The reactant gas mixture is fed into a reactor where it comes into contact with a catalytically effective amount of an oxidized metal catalyst structure, oxidized catalyst or oxidized catalyst system. In addition to at least one oxidized metal selected from the group consisting of rhodium, ruthenium, rhenium, platinum, palladium, iridium and osmium the catalyst further comprises at least one lanthanide where the lanthanide is selected from the group consisting of praseodymium (Pr), neodymium (Nd), promethium (Pm), samarium (Sm), europium (Eu), gadolinium (Gd), terbium (Th), dysprosium (Dy), holmium (Ho), erbium (Er), thulium (Tm), lutetium (Lu), or ytterbium (Yb); more preferably promethium (Pr), samarium (Sm), and ytterbium (Yb); most preferably samarium (Sm). Advantageously, certain preferred embodiments of the process are capable of operating at superatmospheric reactant gas pressures (preferably in excess of 2 atmospheres or about 200 kPa) to efficiently produce synthesis gas. Preferably the oxidized metal is at least one oxidized d-block transition metal or combination thereof; more preferably at least one oxidized Group 8, 9 or 10 metal or combination thereof, and most preferably rhodium.

In accordance with certain embodiments of the present invention, a method of partially oxidizing a reactant gas mixture comprising a light hydrocarbon and oxygen to provide a product stream containing carbon monoxide and hydrogen is provided. This method comprises, in a reactor, passing the reactant gas mixture over an oxidized Rh catalyst structure such that the reactant gas mixture is exposed to a significant portion of the oxidized rhodium.

According to certain preferred embodiments of the present invention, a highly productive process for partially oxidizing a reactant gas mixture comprising methane and oxygen to form synthesis gas comprising carbon monoxide and hydrogen is provided. This process comprises passing the reactant gas mixture over a catalyst structure in a reactor under process conditions that include maintaining a molar ratio of methane to oxygen ratio in the range of about 1.5:1 to about 3.3:1, the gas hourly space velocity is maintained in excess of about 20,000 hr⁻¹, the reactant gas mixture is maintained at a pressure in excess of about two atmospheres and at a preheat temperature of between about 30° C. and about 750° C. Under these process conditions within the reactor, the high surface area oxidized catalyst structure causes the partial oxidation of the methane to proceed at high productivity, i.e., with at least 80% methane conversion, 80% selectivity to carbon monoxide and 80% selectivity to hydrogen. In preferred embodiments, the productivity is at least 85% methane conversion, 85% selectivity to carbon monoxide, and 85% selectivity to hydrogen, more preferably at least 90% methane conversion, 90% selectivity to carbon monoxide and 90% selectivity to hydrogen. In preferred embodiments the catalyst used for producing synthesis gas comprises about 0.005 to 25 wt % oxidized Rh, preferably 0.05 to 25 wt % oxidized Rh, and about 0.005 to 25 wt % of a lanthanide element (i.e., La, Ce, Pr, Nd, Pm, Sm, Eu, Gd, Tb, Dy, Ho, Er, Tm, Yb and Lu) in the form of the metal and/or metal oxide coating a refractory monolith or coating a plurality of distinct or discrete structures or particulates. Weight percents (wt %) refer to the weight of rhodium or lanthanide metal relative to the total weight of the catalyst and support. In some embodiments, the lanthanide is preferably other than lanthanum or cerium. The more preferred compositions contain 0.5-10 wt % oxidized Rh and 0.5-10 wt % Sm on a refractory support. In certain preferred embodiments the ratio of rhodium to lanthanide is in the range of about 0.5-2. The terms “distinct” or “discrete” structures or units, as used herein, refer to supports in the form of divided materials such as granules, beads, pills, pellets, cylinders, trilobes, extrudates, spheres or other rounded shapes, or another manufactured configuration. Alternatively, the divided material may be in the form of irregularly shaped particles. Preferably at least a majority (i.e., >50%) of the particles or distinct structures have a maximum characteristic length (i.e., longest dimension) of less than six millimeters, preferably less than three millimeters. The term “monolith” as used herein is any singular piece of material of continuous manufacture such as solid pieces of metal or metal oxide or foam materials or honeycomb structures. In some embodiments, two or more catalyst monoliths are stacked in the catalyst zone of the reactor. In any case, the new oxidized metal-Lanthanide catalyst systems or catalyst beds have sufficient porosity, or sufficiently low resistance to gas flow, to permit a stream of said reactant gas mixture to pass over the catalyst at a gas hourly space velocity (GHSV) of at least about 20,000 hr⁻¹, which corresponds to a weight hourly space velocity (WHSV) of about 200 hr⁻¹, when the reactor is operated to produce synthesis gas. Preferably the reactor is operated at a reactant gas pressure greater than 2 atmospheres, which is advantageous for optimizing syngas production space-time yields.

In some embodiments, the reactant gas mixture is preheated to a temperature between about 30° C.-750° C. before contacting the catalyst. The preheated feed gases pass through the catalytic materials to the point at which the partial oxidation reaction initiates. An overall or net catalytic partial oxidation (CPOX) reaction ensues, and the reaction conditions are maintained to promote continuation of the process, which preferably is sustained autothermally.

For the purposes of this disclosure, the term “net partial oxidation reaction” means that the partial oxidation reaction shown in Reaction 2, above, predominates. However, other reactions such as steam reforming (see Reaction 1), dry reforming (Reaction 5) and/or water-gas shift (Reaction 6) may also occur to a lesser extent.

CH₄+CO₂⇄2CO+2H₂ (5)

CO+H₂O⇄CO₂+H₂ (6)

The relative amounts of the CO and H₂ in the reaction product mixture resulting from the catalytic net partial oxidation of the methane, or natural gas, and oxygen feed mixture are about 2:1 H₂:CO, similar to the stoichiometric amounts produced in the partial oxidation reaction of Reaction 2.

As used herein, the term “autothermal” means that after initiation of the partial oxidation reaction, no additional or external heat must be supplied to the catalyst in order for the production of synthesis gas to continue. Under autothermal reaction conditions the feed is partially oxidized and the heat produced by that exothermic reaction drives the continued net partial oxidation reaction. Consequently, under autothermal process conditions there is no external heat source required. The net partial oxidation reaction conditions are promoted by optimizing the concentrations of hydrocarbon and O₂ in the reactant gas mixture, preferably within the range of about a 1.5:1 to about 3.3:1 ratio of carbon:O₂ by weight. In some embodiments, steam may also be added to produce extra hydrogen and to control the outlet temperature. The ratio of steam to carbon by weight ranges from 0 to 1. The carbon:O₂ ratio is the most important variable for maintaining the autothermal reaction and the desired product selectivities. Pressure, residence time, amount of feed preheat and amount of nitrogen dilution, if used, also affect the reaction products. The process also includes maintaining a catalyst residence time of no more than about 10 milliseconds for the reactant gas mixture. This is accomplished by passing the reactant gas mixture over, or through the porous structure of the catalyst system at a gas hourly space velocity of about 20,000-100,000,000 hr⁻¹, preferably about 100,000-25,000,000 hr⁻¹; more preferably about 100,000-2,000,000 hr⁻¹. This range of preferred gas hourly space velocities corresponds to a weight hourly space velocity of 1,000 to 25,000 hr⁻¹. In preferred embodiments of the process, the catalyst system catalyzes the net partial oxidation of at least 90% of a methane feedstock to CO and H₂ with a selectivity for CO and H₂ products of at least about 90% CO and 90% H₂.

In certain embodiments of the process, the step of maintaining net partial oxidation reaction promoting conditions includes keeping the temperature of the reactant gas mixture at about 30° C.-750° C. and keeping the temperature of the catalyst at about 600-2,000° C., preferably between about 600-1,600° C., by self-sustaining reaction. In some embodiments, the process includes maintaining the reactant gas mixture at a pressure of about 100-4,000 kPa (about 1-40 atmospheres), preferably about 200-3,000 kPa (about 2-30 atmospheres), while contacting the catalyst.

In some embodiments, the process comprises mixing a methane-containing feedstock and an O₂-containing feedstock together in a carbon:O₂ ratio of about 1.5:1 to about 3.3:1, preferably of about 1.7:1 to about 2.1:1, and more preferably of about 1.8:1 to about 2:1. Preferably the methane-containing feedstock is at least 80% methane, more preferably at least 90%.

According to certain embodiments of the present invention, a method of converting a light hydrocarbon and O₂ to a product mixture containing CO and H₂ is provided. The process includes forming a reactant gas mixture comprising a light hydrocarbon containing gas and an O₂ containing gas, and, in a reactor, passing the reactant gas mixture over a refractory supported oxidized rhodium-lanthanide catalyst prepared by sequentially applying a rhodium precursor, such as a rhodium salt, to a lanthanide and/or lanthanide oxide precursor, such as a lanthanide salt, to the support and stabilizing the catalyst. The term “refractory support” refers to any material that is mechanically stable to the high temperatures of a catalytic partial oxidation reaction, which is typically 500° C.-1,600° C., but may be as high as 2000° C. Suitable refractory support materials include zirconia, magnesium stabilized zirconia, zirconia stabilized alumina, yttrium stabilized zirconia, calcium stabilized zirconia, alumina, cordierite, titania, silica, magnesia, niobia, vanadia, carbide, silicon carbide, nitride, carbide-nitride, and the combinations thereof. A preferred refractory support is alpha-alumina. Stabilizing includes thermally conditioning the catalyst.

The catalyst employed in the method is preferably prepared by sequentially applying a lanthanide precursor and a rhodium precursor to a refractory support and thermally conditioning the catalyst during catalyst preparation. “Thermally conditioning” means that when the catalyst is being constructed (e.g., after the lanthanide precursor is applied to the refractory support and/or after the rhodium precursor is applied to the lanthanide and/or lanthanide oxide), it is subjected to two or more heat treatments which yield a more stable and long lived catalyst for use in the CPOX reactor. Each heat treatment includes calcining the catalyst, or an intermediate stage of the catalyst, according to a defined heating and cooling program. Preferably the final heat treatment includes heating at a temperature that approaches or approximates the operating temperature of the CPOX reactor. It is also preferable to apply the lanthanide or lanthanide oxide precursor compound to a refractory support first, followed by a programmed heat treatment, to further enhance catalyst stability when used onstream in a CPOX reactor. Although less preferred, the lanthanide may instead be applied over the rhodium, or the rhodium and lanthanide precursor compounds may be mixed together and applied to a refractory support, followed by one or more thermal conditioning treatments.

In certain embodiments, thermal conditioning comprises heating the catalyst at a predetermined heating rate up to a first temperature and then heating said catalyst at a predetermined heating rate from the first temperature to a second temperature. In some embodiments of the catalyst preparation method, thermal conditioning also includes holding the catalyst, at the first and second temperatures for predetermined periods of time. In some embodiments, the first temperature is about 125-325° C. and the second temperature is about 300 to 1200° C., preferably about 500-700° C. In some embodiments the heating rate is about 1-10° C./min, preferably 3-5° C./min and the dwell time at at least one of the first and second temperatures is about 120-360 min, or more, preferably about 180 min.

In some embodiments, thermal conditioning of the catalyst includes heat treating the catalyst between the sequential applications of lanthanide and/or lanthanide oxide precursor compound and oxidized rhodium precursor compound to said support, i.e., treating an intermediate-stage catalyst. In some embodiments, the catalyst preparation method also includes partially reducing the catalyst at a predetermined temperature in a reducing atmosphere prior to contacting of the reactant gas. The resulting Rh-lanthanide containing catalyst is characterized by its enhanced activity for catalyzing the partial oxidation of light hydrocarbons such as methane, compared to other rhodium-based catalysts.

In certain embodiments of the syngas production process, the reactor is operated at the above-described process conditions to favor autothermal catalytic partial oxidation of the hydrocarbon feed and to optimize the yield and selectivity of the desired CO and H₂ products.

According to certain embodiments of the present invention, a method of converting light hydrocarbon and O₂ to a product mixture containing CO and H₂ is provided. The process includes forming a reactant gas mixture comprising a light hydrocarbon containing gas and an O₂ containing gas, and the reactant gas mixture is fed into a reactor where it comes into contact with a catalytically effective amount of oxidized metal catalyst structure, catalyst or catalyst system. The catalyst system can be an oxidized metal, or oxidized metal on a refractory support. Preferably, the refractory support is lanthanide containing or lanthanide coated. Preferably the catalyst system is lanthanide-containing or lanthanide-coated, where the lanthanide is selected from the group consisting of Pr, Nd, Pm, Sm, Eu, Gd, Th, Dy, Ho, Er, Tm Yb and Lu; more preferably selected from the group consisting of Pr, Sm and Yb. Preferably the oxidized metal is an oxidized form of a Group 8, 9 or 10 metal, or a combination thereof, more preferably, the oxidized metal is oxidized Rh.

In yet another embodiment, a method of partially oxidizing a reactant gas mixture comprising a hydrocarbon-containing gas and an oxygen-containing gas to form a product mixture comprising carbon monoxide and hydrogen, comprises heating the oxidized metal catalyst in the reactant gas mixture containing a hydrocarbon-containing gas and oxygen-containing gas to achieve the light-off point for the catalyst and initiate the selective oxidation process. The hydrocarbon-containing gas may be natural gas and may comprise methane, ethane, propane, and butane; methane is preferred. The oxygen-containing gas may be oxygen, oxygen-enriched air, air, or any gas comprising oxygen. It has been found that this method using the oxidized catalysts of the present invention initiates the selective oxidation reaction at comparatively low temperatures, ranging from 150° C. to 500° C. Without wishing to be bound by any particular theory, we believe that the lattice oxygen in the oxidized metal reacts with hydrocarbon feeds exothermically to initiate the selective oxidation process. After the initiation, the oxidized metal may stay as either oxidized form or metallic form depending on the reaction conditions.

### EXAMPLES

### Example 1

### Catalyst Synthesis

A ZrO₂ supported catalyst comprising 3.13% Rh and 4.52% Sm₂O₃ was made according to Example 1 of International Publication No. WO 02/20395 with the additional step of a final oxidation in air at 700° C. for 3 hours to provide an oxidized rhodium catalyst.

### Example 2

### Fixed Bed Reactor Results

2 grams of catalyst from Example 1 were loaded into a fixed bed reactor and heated at 5° C./min in a reactant gas mixture comprising CH₄/O₂/He, 160/84/60 (volume basis).

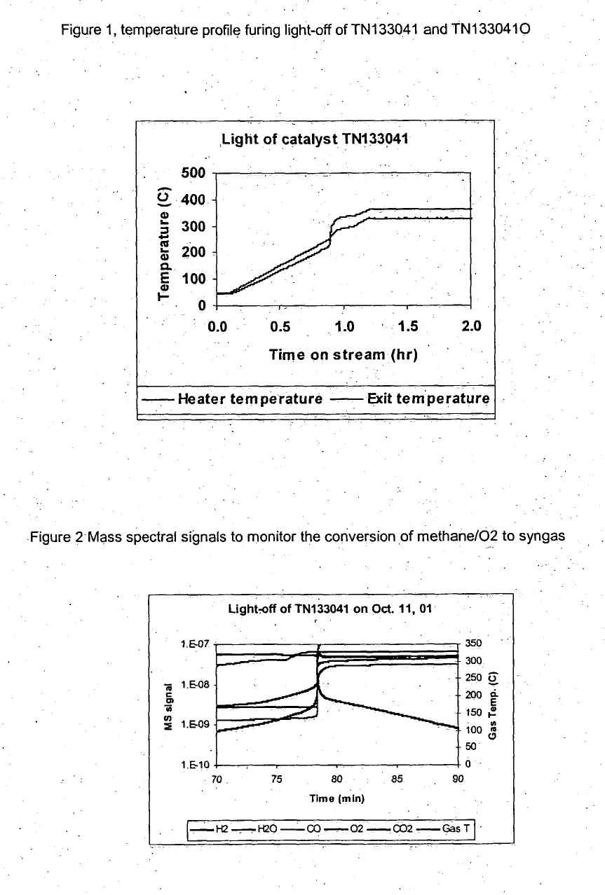

FIG. 1 shows that at approximately 250° C., the exit gas temperature jumps sharply beyond the heater temperature, indicating that the light-off, or initiation temperature, has been reached. This is substantially (ca. 75° C.) lower than the light-off temperature reached using a catalyst with a non-oxidized metal.

### Example 3

### Catalyst Synthesis

An alumina supported catalyst of Rh and Sm₂O₃ was made according to Example 1 of International Publication No. WO 02/20395 with the elimination of the reduction step, leaving the final oxidation as the activation step to provide an oxidized metal catalyst.

### Example 4

### Productivity for Synthesis Gas

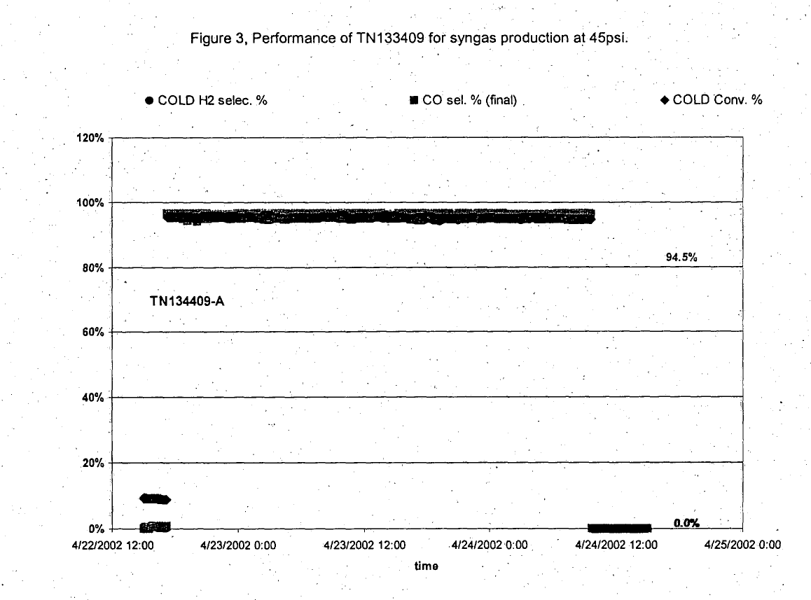

The catalyst of Example 3 was tested according to Test Procedure 1 of International Publication No. WO 02/20395. FIG. 3 indicates the performance of the catalyst from Example 4 revealing a methane conversion of approximately 95% and selectivity for CO of 96% and for H₂ of 94%.

1. A method of making a catalyst comprising
at least one oxidized metal wherein the metal is selected from the group consisting of rhodium, ruthenium, rhenium, platinum, palladium, iridium, and osmium;
at least one lanthanide; and
a refractory support
wherein said catalyst is effective for at least partially oxidizing a reactant gas comprising at least one hydrocarbon and oxygen to a product stream comprising hydrogen and carbon monoxide and wherein the method of making the catalyst comprises
a) depositing at least one metal-containing compound onto a refractory support; and
b) depositing at least one lanthanide-containing compound onto a refractory support; in a manner effective for producing a catalyst precursor material; and
c) calcining the catalyst precursor material under conditions effective for producing a catalyst comprising an oxidized metal.

2. The method according to claim 1 wherein at least one hydrocarbon is selected from the group consisting of methane, ethane, ethylene, propane, propylene, butane, 1-butene, 2-butene, isobutene, and isobutylene.

3. The method according to claim 1 wherein at least one hydrocarbon is methane.

4. The method according to claim 1 wherein the reactant gas comprises natural gas.

5. The method according to claim 1 wherein the oxygen is introduced to the reactant gas as at least one selected from the group consisting of air, oxygen, and any combination thereof.

6. The method according to claim 1 wherein the product stream comprises hydrogen (H₂) and carbon monoxide (CO) in a ratio between about 5:1 H₂:CO and about 1:2 H₂:CO.

7. The method according to claim 1 wherein the product stream comprises hydrogen (H₂) and carbon monoxide (CO) in a ratio between about 1.7:1 and about 2.1:1 H₂:CO.

8. The method according to claim 1 wherein steps a and b are performed simultaneously.

9. The method according to claim 1 wherein steps a and b are performed separately.

10. The method according to claim 1 wherein any depositing step may comprise impregnation.

11. The method according to claim 10 wherein any depositing step may comprise calcination.

12. The method according to claim 1 wherein the refractory support comprises at least one selected from the group consisting of silicon, aluminum, zirconium, titanium, magnesium, yttrium, calcium, carbides, nitrides, stabilized zirconia, zirconia-stabilized alumina, and any combination thereof.

13. The method according to claim 12 wherein the refractory support comprises an oxide comprising at least one element selected from the group consisting of aluminum, titanium, zirconium, silicon, and magnesium.

14. The method according to claim 1 further comprising reducing the catalyst precursor material.

15. The method according to claim 14 wherein reducing the catalyst precursor material takes place prior to calcining the catalyst precursor material.

16. The method according to claim 14 wherein reducing the catalyst precursor material is carried out in a manner such that at least a portion of the metal of the catalyst precursor material is at least partially reduced.

17. The method according to claim 14 wherein reducing the catalyst precursor is carried out in a manner such that at least a portion of the metal of the catalyst precursor material is present in a zero oxidation state.

18. The method according to claim 1 wherein calcining the catalyst precursor further comprises
at least one thermal conditioning step wherein said thermal conditioning comprises
heating the catalyst precursor material in air at a first heating rate up to a first temperature; and
heating the catalyst precursor material in air at a second heating rate from the first temperature to a second temperature.

19. The method according to claim 1 wherein depositing at least one metal-containing compound in (a) further comprises at least one thermal conditioning step wherein said thermal conditioning comprises
(a) heating the catalyst precursor material in air at a first heating rate up to a first temperature; and
(b) heating the catalyst precursor material in air at a second heating rate from the first temperature to a second temperature.

20. The method according to claim 1 wherein the metal-containing compound comprises at least one selected from the group consisting of the d-block transition metals.

21. The method according to claim 1 wherein the metal-containing compound comprises at least one metal selected from the group consisting of Groups 8, 9 and 10 of The Periodic Table of the Elements.

22. The method according to claim 1 wherein the metal-containing compound comprises at least one metal selected from the group consisting of rhodium, ruthenium, rhenium, platinum, palladium, iridium and osmium.

23. The method according to claim 1 wherein the metal-containing compound comprises rhodium.

24. The method according to claim 1 wherein the lanthanide-containing compound comprises at least one element selected from the group consisting of La, Ce, Pr, Nd, Pm, Sm, Eu, Gd, Th, Dy, Ho, Er, Tm, Yb, and Lu.

25. A catalyst effective for at least partially oxidizing a reactant gas comprising at least one hydrocarbon and oxygen to a product stream comprising hydrogen and carbon monoxide said catalyst comprising
(a) at least one oxidized metal wherein the metal is selected from the group consisting of rhodium, ruthenium, rhenium, platinum, palladium, iridium, and osmium;
(b) at least one lanthanide; and
(c) a refractory support.

26. The catalyst according to claim 25 wherein at least one hydrocarbon is selected from the group consisting of methane, ethane, ethylene, propane, propylene, butane, 1-butene, 2-butene, isobutene, and isobutylene.

27. The catalyst according to claim 25 wherein at least one hydrocarbon is methane.

28. The catalyst according to claim 25 wherein the reactant gas comprises natural gas.

29. The catalyst according to claim 25 wherein the oxygen is introduced to the reactant gas as at least one selected from the group consisting of air, molecular oxygen, and any combination thereof.

30. The catalyst according to claim 25 wherein the product stream comprises hydrogen (H₂) and carbon monoxide (CO) in a ratio between about 5:1 H₂:CO and about 1:2 H₂:CO.

31. The catalyst according to claim 25 wherein the product stream comprises hydrogen (H₂) and carbon monoxide (CO) in a ratio of between about 1.7:1 H₂:CO and about 2.1:1 H₂:CO.

32. The catalyst according to claim 25 wherein at least one oxidized metal is oxidized rhodium.

33. The catalyst according to claim 32 wherein the refractory support comprises at least one oxide wherein the oxide comprises at least one selected from the group consisting of aluminum, titanium, zirconium, silicon, and magnesium.

34. The catalyst according to claim 25 wherein at least one lanthanide is selected from the group consisting of Pr, Nd, Pm, Sm, Eu, Gd, Th, Dy, Ho, Er, Tm, Lu and Yb.

35. The catalyst according to claim 25 wherein at least one lanthanide is selected from the group consisting of Pr, Sm, and Yb.

36. The catalyst according to claim 25 wherein at least one lanthanide is Sm.

37. The catalyst according to claim 25 wherein the refractory support comprises at least one material selected from the group consisting of silicon-containing compounds, aluminum-containing compounds, zirconium-containing compounds, titanium-containing compounds, magnesium-containing compounds, stabilized zirconia, zirconia-stabilized alumina, yttrium-containing compounds, calcium-containing compounds, carbide-containing compounds, and nitride-containing compounds.

38. A process for at least partially oxidizing a reactant gas comprising at least one hydrocarbon and oxygen wherein the process comprises
contacting a catalyst with the reactant gas under conditions sufficient to
(a) initiate the partial oxidation reaction; and
(b) provide a product stream comprising hydrogen and carbon monoxide
said catalyst comprising
at least one oxidized metal wherein the metal is selected from the group consisting of rhodium, ruthenium, rhenium, platinum, palladium, iridium, and osmium;
at least one lanthanide; and
a refractory support.

39. The process according to claim 38 wherein at least one hydrocarbon is selected from the group consisting of methane, ethane, ethylene, propane, propylene, butane, 1-butene, 2-butene, isobutene, and isobutylene.

40. The process according to claim 38 wherein at least one hydrocarbon is methane.

41. The process according to claim 38 wherein the reactant gas comprises natural gas.

42. The process according to claim 38 wherein the oxygen is introduced to the reactant gas as at least one selected from the group consisting of air, molecular oxygen, and any combination thereof.

43. The process according to claim 38 wherein the product stream comprises hydrogen (H₂) and carbon monoxide (CO) in a ratio between about 5:1 H₂:CO and about 1:2 H₂:CO.

44. The process according to claim 38 wherein the product stream comprises hydrogen (H₂) and carbon monoxide (CO) in a ratio of between about 1.7:1 H₂:CO and about 2.1:1 H₂:CO.

45. The process according to claim 38 wherein conditions sufficient to initiate the partial oxidation reaction comprise a temperature between about 150° C. and about 500° C.
